(19) United States
(12) Patent Application Publication
(10) Pub. No.: US 2017/0053543 A1
(43) Pub. Date: Feb. 23, 2017

(54) COMMENTING AND PERFORMANCE SCORING SYSTEM FOR MEDICAL VIDEOS

(71) Applicant: Surgus, Inc., Fremont, CA (US)

(72) Inventors: Vivek Agrawal, Fremont, CA (US); Jean-Sebastien Legare, Vancouver (CA); Daniel J. Naab, Madison, WI (US); Renzo Maicol Olguin, Arlington, VA (US)

(73) Assignee: Surgus, Inc., Fremont, CA (US)

(21) Appl. No.: 15/243,013

(22) Filed: Aug. 22, 2016

Related U.S. Application Data
(60) Provisional application No. 62/208,699, filed on Aug. 22, 2015.

(51) Int. Cl. G09B 5/06; G06F 3/0482; G06F 3/0484; G06F 17/24; G11B 27/036

(52) U.S. Cl. CPC G09B 5/065; G06F 17/241; G11B 27/036; G06F 3/04847; G06F 3/0482

(57) ABSTRACT

A video system that provides feedback, coaching, assessment, and training to surgeons integrating objective skills assessment tools to a video or live feed of the surgical procedure.

### CROSS-REFERENCES TO RELATED APPLICATIONS

This application claims the benefit of U.S. provisional application No. 62/208,699, filed on Aug. 22, 2015, which is expressly incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The current system is a version of the surgery residency model first introduced at Johns Hopkins University medical School by William Halstead, their first chief of the Department of Surgery in 1890. This included in person apprentice-based training. In other words, the resident first works with the experienced attending surgeon and over many years, gains the confidence of the attending and starts to perform the surgery on their own. An attending surgeon almost always remains in the operating room during residency. When the surgeon completes their training, they rarely get any further feedback, in person or otherwise and often their growth hits a plateau. For over 100 years, there was no quantifiable system to rate surgeons, but in 2004 Southern Illinois University Medical School developed an objective assessment of surgical skills called the Operative Performance Rating System (OPRS), approved and now required by the American Board of Surgery, to rate surgeons for global or “general” and “procedure-specific” criteria. In surgical parlance, a case or surgery will consist of many procedures or steps that are similar from surgery to surgery, independent of the patient. For example, in a mesh insertion for an open hernia surgery, the steps would include Identification of Indirect Hernia Sac, Identification of Anatomic Landmarks for Mesh Placement, and Mesh Placement. The OPRS uses a 5 point Likert scale to rate the surgeon (poor, fair, good, very good, excellent) for each step (procedure) as well as global or general criteria such as “Respect for Tissue,” “Operative flow,” “Time and motion.” Over 10 years of research published in peer-reviewed medical journals have verified the value of the OPRS and other objective quantification assessment tools, primarily by showing that the scores for residents improve year over year as they progress through a residency and fellowship program.

There are many objective assessments of surgical skills (both technical and non-technical) that are published. The OPRS, shown in FIGS. 1A-D, is an example for technical skills. For non-technical skills, there are objective assessment tools such as NOTSS (non-technical skills for surgeons).

According to current practice, attending surgeons or proctor/preceptors use objective assessments to assess the surgeon using a printout of the assessment tool and write their assessment on the paper. That paper is then submitted to the authorities and makes its way to the student surgeon. Research shows that if there is a 3- or more day delay between the surgery and the assessment, the coaching surgeon's memory is no longer reliable to provide an accurate assessment. The University of California, Los Angeles (UCLA) has developed a mobile Google Doc with the OPRS questions for surgeons to leave feedback. However, even with this process, the student rarely gets sufficiently specific information to be able to relate the feedback to their assessed surgery, especially after some time has passed.

The American Board of Surgery requires that residents submit OPRS assessments for board certification. They allow electronic submission of the forms through New Innovations residency management software.

In Germany, industry boards require experienced surgeons to peer review each other. The way they do this is to send DVDs of the recorded surgeries and rate the surgeon on a paper form and submit the paper form to the governing body.

A New England Journal of Medicine article in 2013 showed that in peer review of surgical skills in a video, the scores are correlated to mortality and patient outcomes (infections, complications, etc.).

There is a dearth of qualified surgeons worldwide who can perform live-saving procedures. The Lancet Commission on Global Surgery published a special April, 2015 issue noting that 4.9 billion people cannot access safe and affordable surgical care, that “millions of people are dying unnecessarily,” and inadequate surgical care will cost the global economy USD$12.3 trillion from 2015 to 2030. One reason for the lack of access is the shortage of trained surgeons. The authors called for an investment of USD$420 billion to improve surgical access in 88 countries that have the highest need.

### BRIEF SUMMARY

Generally, a computer-assisted surgery assessment system using video playback is described. A video of a surgery can be divided into chapters or other subsections, and rating buttons for different surgical tasks can be enabled or disabled at any point in the video. When a reviewer clicks an enabled button, a scorecard interface pops up. The scorecard has selections for scores that can be added by any of a number of means, for example, textual descriptions, audio input (transcribed or not), video input, drawings, uploaded links, uploaded pictures, uploaded videos, and tagging of people for each score. In one embodiment, the user can select the score that is most applicable to the technique being attempted by a surgeon, and the video moves on. In another embodiment, the video can be configured by a user such that it continues to paly while the user selects the score that is most applicable to the technique being attempted. The reviewer input can act as anchors or points of reference so that the criteria for assessment is the same from one reviewer to another.

Also described is a process for setting up an assessment system, which employs an Assessment Template which includes “chapters” that can be used to identify the various procedures in a surgical video and may include a stored file of predetermined score ranges and associated text descriptions for the scores. An individual, e.g., an editor can divide a raw video into different subsections and assign scorecards for different techniques to the subsections.

Use of the video playback system described herein as a computer-assisted surgery assessment system is one example of the utility of the system. The functional characteristics of the video playback system find further utility in evaluating, storing, and transmitting information used in medical imaging, for example using a Digital Imaging and Communications in Medicine (DICOM) file format applicable to CT scans, MRI scans, angiograms and the like.

### BRIEF DESCRIPTION OF THE DRAWINGS

FIGS. 1A-D are a schematic depiction of an example of an OPRS from the American Board of Surgery, with open inguinal hernia provided as the exemplary surgery.

FIG. 2A depict a video uploaded to the platform with no permissions or metrics assigned in accordance with an embodiment, and FIG. 2B illustrates the settings page where assessments can be uploaded or edited.

FIG. 3 depicts a graph showing that feedback during the video timeline can have separate sections for each “chapter” or step in the surgery.

FIG. 4A illustrates how arrows represent numerous different ways a user can access or engage various locations in the video in accordance with an embodiment, and FIG. 4B shows play buttons (slow play, regular speed play, and fast forward play) that are overlaid on the video player for easy access, wherein each click makes the video play faster or slower until a limit is reached.

FIG. 5 illustrates how markers in the form of a vertical line, icon, text, picture, or other identifier to call attention to certain moments in the video in accordance with an embodiment.

FIG. 6 illustrates an optional embodiment where assessment buttons are grayed out when a video is not in the right time period in the video for an assessment and the assessment is not relevant. In the figure, the second “chapter” is operational, but the first and third sections (or “chapters”) are grayed out.

FIG. 7 illustrates an embodiment where when an assessment button is pressed, and a pop up window or overlay appears giving the user scoring options. In this case, the user can choose 6 options (5 scores and one “N/A” option), wherein each score can have a description to help the user choose the appropriate score.

FIG. 8 illustrates how scores can be shown by way of a bar graph with multiple reviewers for each category with each bar time-coded so the video will play when the bar is clicked at the time the assessment was made in accordance with an embodiment.

FIG. 9 illustrates an embodiment where an assessment template is uploaded where each “chapter” title serves merely as a label, with buttons clickable at any time during video for assessment.

FIG. 10 illustrates an embodiment where when a user with “Admin” permission hovers over a chapter title label, an option to “SET CURRENT TIME” will appear. In the figure, the “Admin” user is hovering over chapter titled “Proc. 2: Dissection of tissue & hernia sac.”

FIG. 11 illustrates an embodiment where the title of the chapter has changed to a clickable link that will allow a user to jump to that time in the video while playing or at pause.

FIG. 12 illustrates how the user can visualize the consistency of a surgeon's performance based on scores of multiple reviewers and the variation of the scores for each metric or criteria. The scores are tied to times in the video which allows user to see the particular event that's tied to the score, and each reviewer's scores have their own color or shade so users can follow a reviewer's feedback.

FIG. 13 illustrates an embodiment where a user can click on the “Comments” tab to see feedback in text, audio, video, or drawing format, all tagged to time.

FIG. 14 illustrates an embodiment where a user can highlight a circle on the video by clicking the center and radius, demonstrating that the outside of the radius will turn darker than the inside, additional highlighting such as flashing or a ring around the circle can further highlight it, and the drawing is time-stamped and also represented in the graph.

FIG. 15 illustrates an embodiment where an arrow can be created by a user as feedback by clicking 3 points.

FIG. 16 illustrates an embodiment in how to turn on various tools for feedback including the drawings, circle highlights, arrows, video feedback, and audio feedback. Each button can be a separate background color which would be represented in the timeline graphs using the corresponding colors to highlight to the user what type of comment was given at any point along the video timeline and when a user clicks on one of these buttons, a secondary tool will allow the user to add details feedback in the format of their choosing with or without prompts.

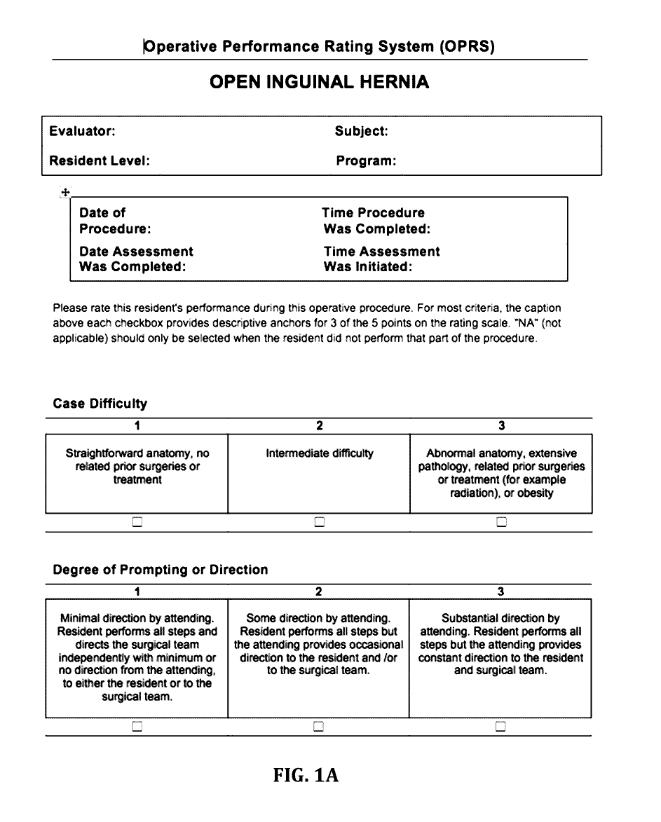

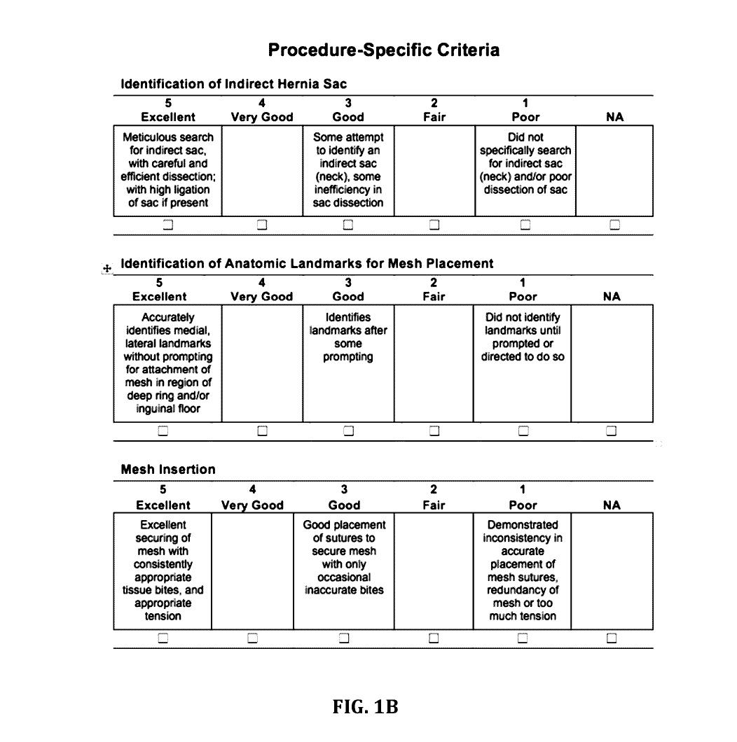

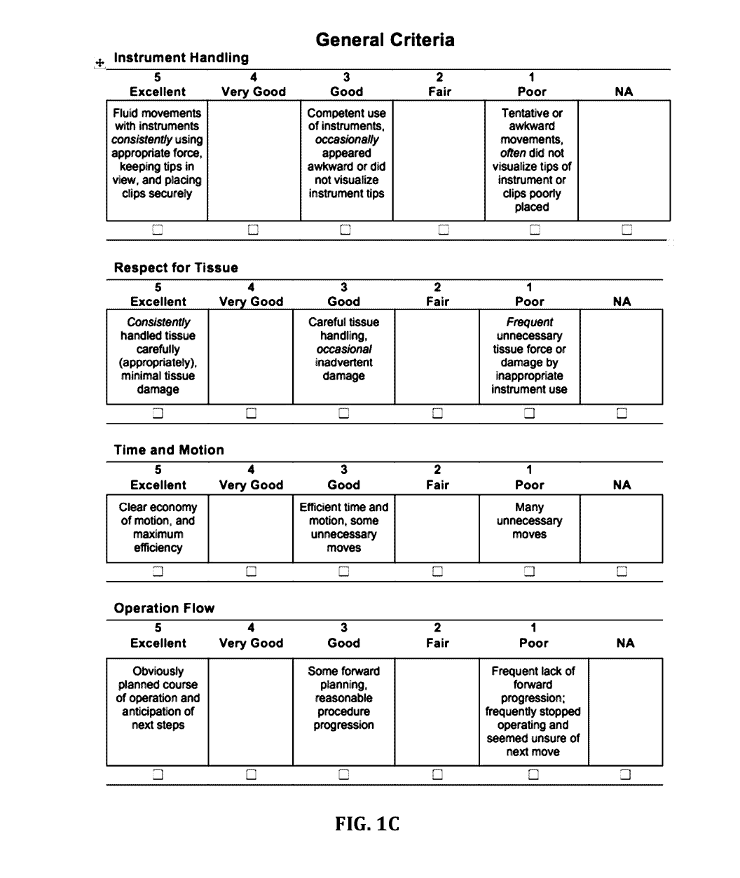

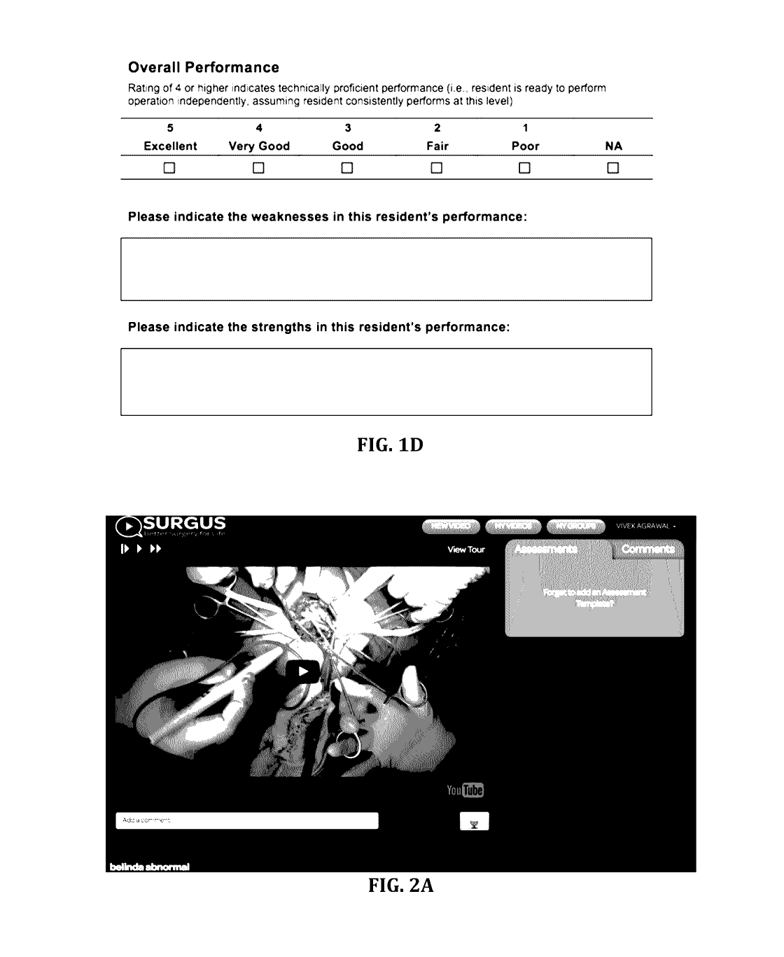

### DETAILED DESCRIPTION

Merely watching a surgery in person and asking reviewer to review it and record assessments or advice fails to do a good job associating a response with a particular moment. In some cases the responses are sent back to the student days/weeks after, which at that point the student has lost the association of what the responses really were for.

Watching a recording of a surgery and asking a reviewer to review it also fails to do a good job for at least the same reasons.

Existing DVD systems often require the reviewer to view the entire video segment, requiring the reviewer to either sit and watch the entire surgical procedure, often hours long. In some cases reviewers might skim over a video and potentially miss segments in which the reviewer needed to provide feedback.

An embodiment platform integrates objective assessment rating tools into the webpage that shows a video of the surgery. This way, there is little-to-no risk of loss of memory resulting in an unreliable assessment. Furthermore, the feedback and assessment scores are tagged to any moment of the video so that they student can relate the score to a moment or moments of their procedure. This allows the student to review their own skills for a stronger experience in improving their performance.

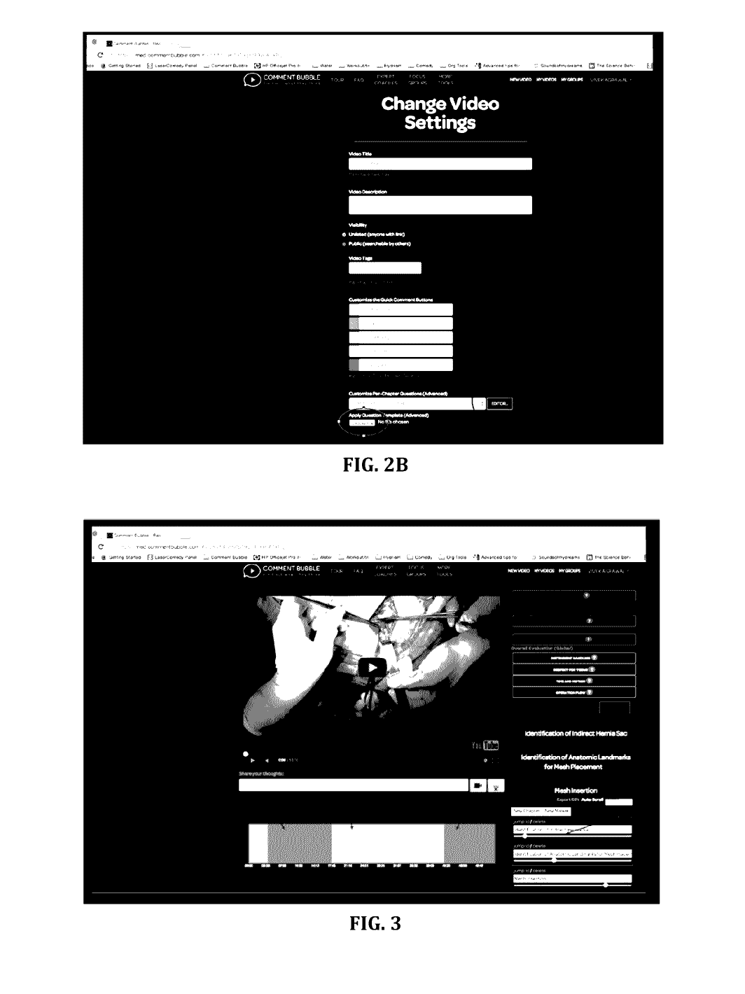

In one embodiment, an EDITOR button for marking chapters or other subsections in videos and associating interactive scorecards with those subsections from a template file allows one to set up a video review session. As shown in FIG. 2, a video may be uploaded to the platform with no permissions or metrics assigned and a user can apply a question template by clicking on the “Choose File” button or clicking on the “EDITOR” button to create a new template. During a playback session, a reviewer can click anywhere in the video, for example, in certain subsections and/or markers within the video to quickly find the techniques that he or she is supposed to grade. The reviewer can select a skill to grade, instantly pausing the video and presenting a scorecard that overlays over a portion of the video as a graphical user interface. A text description acts as an assessment anchor and is juxtaposed with each possible score so that different reviewers are normalized with respect to their assessments.

A “chapter” system is created to identify the various procedures in a surgical video. The scoring metrics can be different for each chapter just as they are in an objective assessment, such as the OPRS. The order of the chapters is maintained even when there are no times associated with any of the chapters.

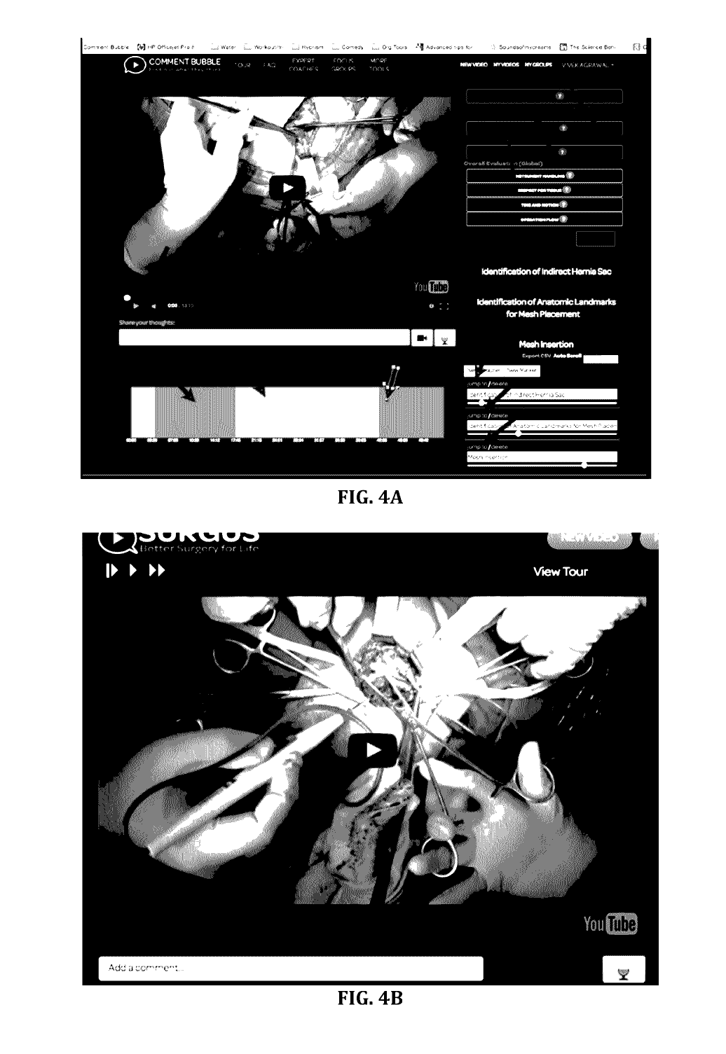

FIG. 4 illustrates the use of arrows in indicating particular features of a video.

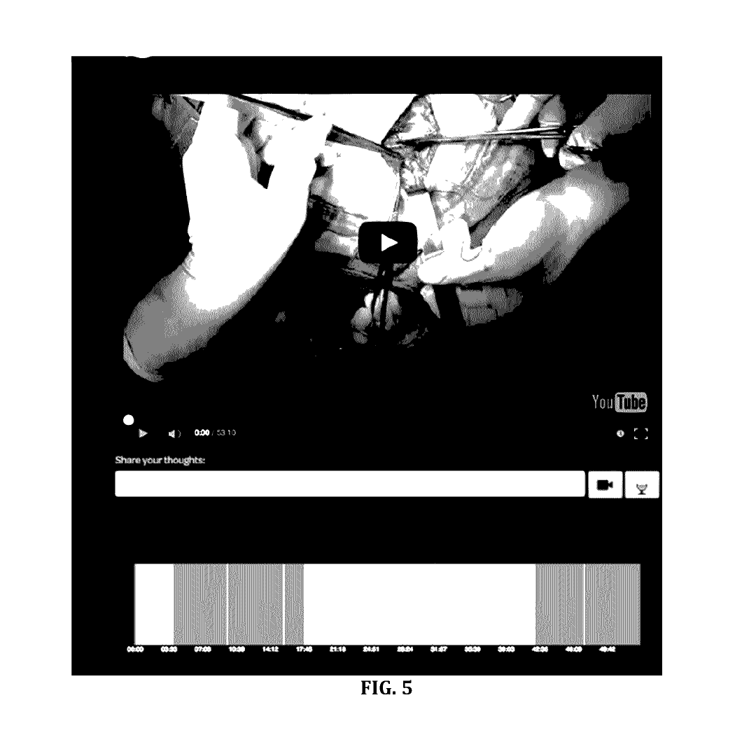

A “marker” system linked to the video timeline provides guidance to the assessing surgeon as to where to focus on the video of the surgery, as shown in FIG. 5. This can save 90% of the time of watching the full surgery. For example, if the surgery is 90 minutes, few surgeons will have the time to watch the entire surgery to assess the student. However, with the markers that tell the assessing surgeon where to focus, and the ability to fast forward the video, they can skip to particular time points or sections of the video, reducing the time necessary for an assessment by 10× or more, providing an efficient workflow for surgeons, instructors, peers and mentors to use the assessment system.

A flexible group and permission system enables roles to be created and the assessment system to have a wide range of applications. For example, a student may or may not be able to see personally identifiable information of the assessors. Similarly, prior to completion of their assessment, the assessors do not see the feedback of other assessors so as not to be influenced. The assessment questions can include a numerical score, a text anchor that says what that score represents (“Accurately identifies medial, lateral landmarks without prompting for attachment of mesh in region of deep ring and/or inguinal floor” [excellent] vs. “Did not identify landmarks until prompted or directed to do so”=poor), description of the score (poor, good, acceptable, excellent, N/A, etc.). In options for the assessment, the system allows for a range of values, each of which can have a text description (Poor, good, very good, etc.) as well as a summary of what that score means (e.g., poor handling of tissue that causes damage). The user can also click to show the user noticed an event (with designation of a value optional). This allows students to get quick feedback, perhaps on the same day, which would otherwise be difficult with paper assessments or even a cloud-based document. The correlation of a video of the surgery with the assessment makes the process more relevant and helpful to the person performing the surgery and the person conducting the assessment.

A web interface provides access to qualified proctors to review your surgical training from anywhere in the world.

The system can be used for live video, such as for live proctoring. Live feeds can be recorded; the assessment tools and tagging implements may be the same as for recorded video. It can also be used for public or private education, business pitches, and other presentations. Other uses include, but are not limited to: refresher training and introducing new techniques in the hospital or clinic setting; a surgeon rating system that could be adopted by a rating organization (for example the American Medical Association “AMA”); FDA submissions; and insurance training or compliance which could be linked to rates.

Navigation with Themes

The system provides at least three main ways of reducing the time needed for a reviewer to review a video: chapters, markers and buttons that allow the reviewer or other user to play the video at high speed (i.e., “fast forward”). Specific points in a video may also be identified by a time stamp.

Chapters include navigational markers for the video including what procedure is occurring (ex: setting up, cleaning, etc.), as shown in FIG. 3. In accordance with an embodiment, a section or chapter is independently clickable so video plays at the start of that section. Each “chapter” can be shown in the graph to be a separate color relative to the background. Markers provide a quick focus point during the video to review.

Automation.

Feedback and scoring of surgeries can be compiled, sorted, and analyzed as to teach a computer algorithm how to make assessments of the surgery with accuracy comparable to an expert surgeon. For example, feedback for a particular surgery across video capture methods, various surgeons, various patients, and other variations can be correlated such that a computer, when accessing a new video, can recognize the type of procedure, each step in the procedure, risks to the patients or particular challenges (i.e. high body mass index creating special circumstances or previous surgeries affecting the tissue, among other variations), and assess the quality of the surgery.

Ability for Quantified Responses

Questions can be entered, a quick comment button is provided for pre-set comments, and annotations are able to be entered naturally. Further, templated questions can be uploaded for videos that share the same set of scoring criteria, and the graph is color coded consistent with the type of feedback such that the user can either click on a comment in the timeline to view the relevant moment in the video, or alternatively, the user can click on the comment itself, which will be highlighted when the user hovers over the comment, and the video will jump to the time associated with that comment.

Roles

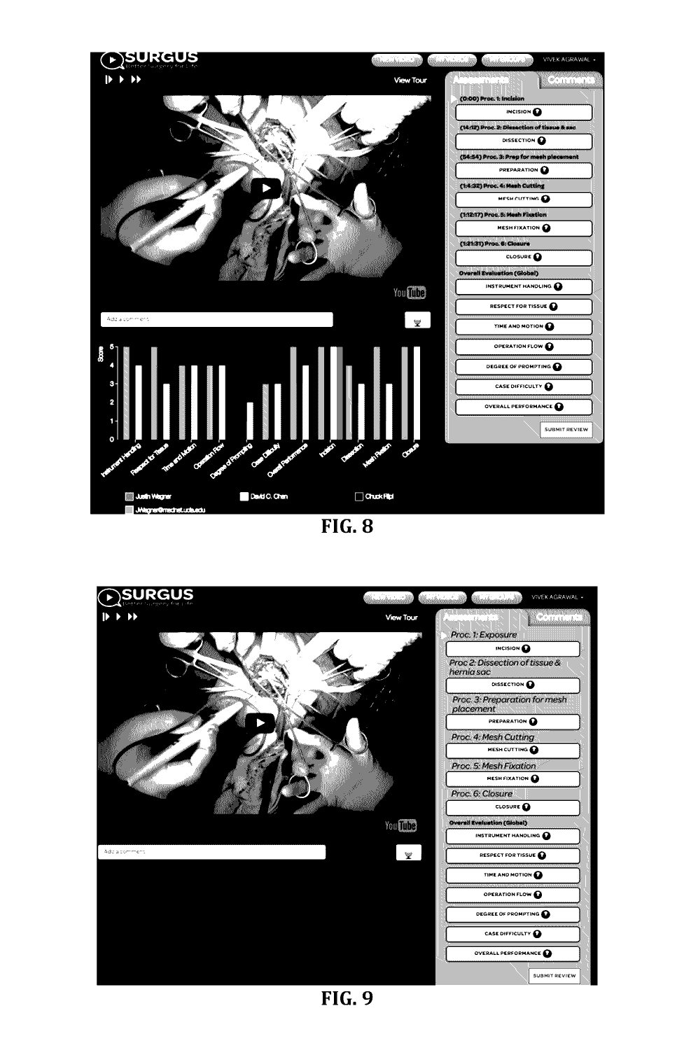

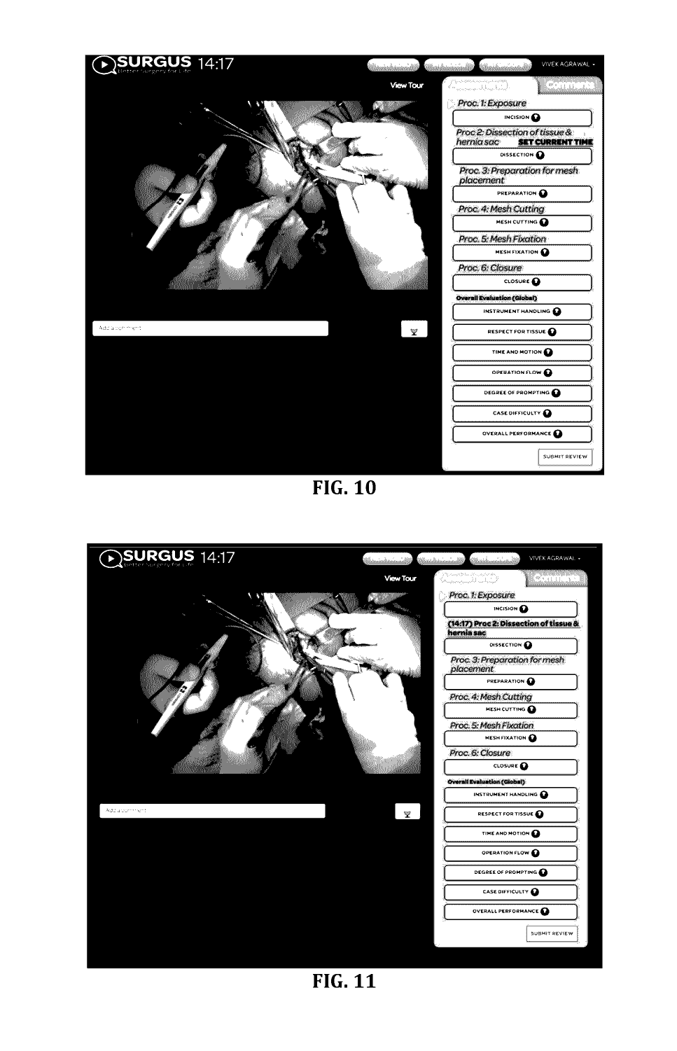

Roles include an “Admin” role wherein the “Admin” person has the ability to change (“permissions”), such as to add reviewers to review the video, configure chapters, configure markers, set questions and modify the assessments. For example as shown in FIG. 10, when a user in an “Admin” role hovers over a chapter title label, an option to “SET CURRENT TIME” will appear. When a user clicks on the SET CURRENT TIME option, “Proc. 2: Dissection of tissue & hernia sac,” the time at which the video is playing or paused, in this case at 14:17, is recorded and the title turns into a clickable link that seeks the video to that time when any user clicks on it. The design of the title will also change from a label to a design signifying to the user that they can click on the link (e.g., it becomes underlined). Roles can include a student role with the ability to view responses from multiple reviewers and upload/sync video files with the system. Roles can also include a reviewer role that views only his/her responses and does not have access to view responses from other reviewers, has quick navigation ability to focus on portions of the video, can provide quantified responses, and can set flexible annotation responses for feedback. Custom roles can also be created. FIG. 8 illustrates how scores can be shown by way of a bar graph with multiple reviewers for each category so the video will play when the bar is clicked.

A comment stats graph can provide students, reviewers, and administrators to view quickly in the video a distribution of responses from reviewers over the duration of the video.

A marker chart gives a view to focus on segments of the video which need feedback from them.

Other provisions are made for uploading videos.

In one use case embodiment, a student (or a 3rd party admin) uploads their video for feedback. The admin (or student or proctor) sets markers, chapters and questions, and adds reviewers to provide feedback. In some cases, the student can also act as an admin. The user can upload a question template of the assessment tool or create one on the video. The reviewer gets notified for reviewing a video, is directed to the segments of the video, and can provide responses from quick actions or by adding annotations to the video.

Other uses of this system include online surgical proctoring, where a student can get feedback on surgical skills by one or many proctors. Further, one can integrate objective assessment metrics for procedure-specific and general criteria into sections of the video or the whole video. For example, a surgeon can create chapters to get feedback, metrics can be different for individual sections of the video, and a numerical score can be provided as feedback. There can be different views for a proctor, student, admin. The permissions system can be customizable so that access to various tools for any role in the workflow can be delegated. One can create templates of questions that are applied to any video. One can use the standards already approved and required by American Board of Surgery. A marker system to highlight areas to be scored or assessed is available, and how one moves from screen to screen is natural.

A central embodiment is a video page that gives features for evaluation and analysis, including a video player, buttons for answers, links to chapter starts, markers on a graph to highlight where to focus, a time graph to summarize where evaluations, assessments, coaching was tagged to the video, and admin functions. In accordance with an embodiment, a library of videos which include reviewer input may be created and used for example like a video textbook.

FIG. 13 illustrates how a user can click on the “Comments” tab tagged to time, and the graph is color coded consistent with the type of feedback such that the user can either click on a comment in the timeline to view the relevant moment in the video, or alternatively, the user can click on the comment itself, which will be highlighted when the user hovers over the comment, and the video will jump to the time associated with that comment.

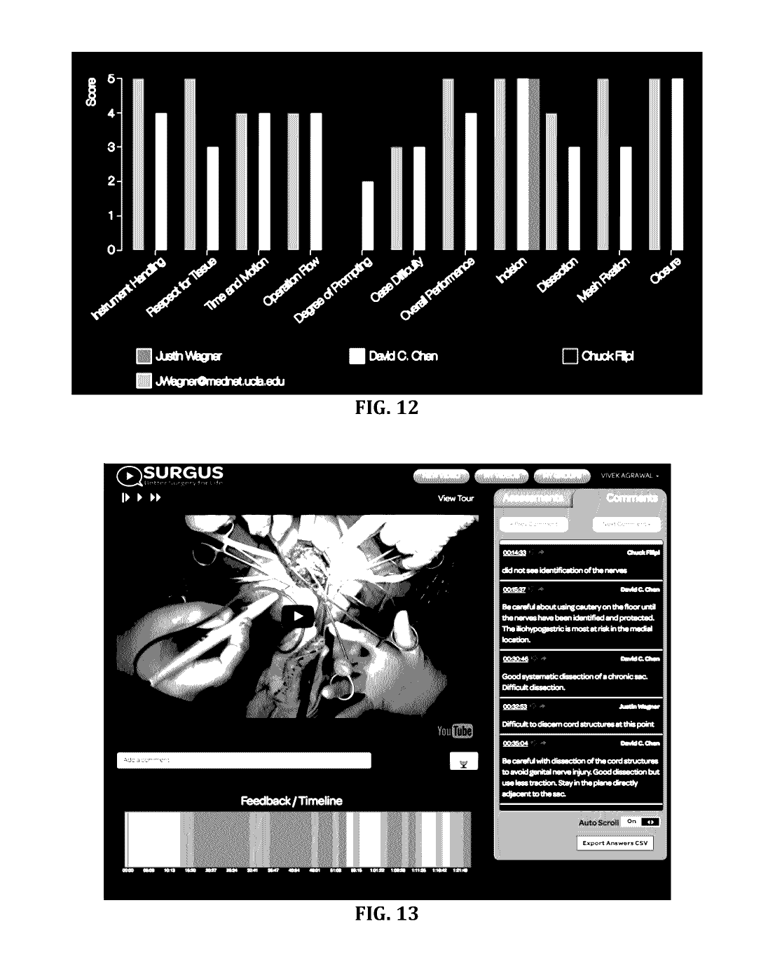

FIG. 12 illustrates how the surgical video system described herein can be used to evaluate the consistency of the performance based on scores of multiple reviewers. This surgical video system provides the ability to download data, showing consistency or changes over time, and may be used for example to show how a surgeon's performance improves over time.

Admin functions to set up the special features are novel, including buttons for setup of markers, buttons to setup start of chapters, and deletion of either markers or chapters.

A groups system can attach roles to each video. Each role has a certain permission of what the grantee of that permission can access on the video page (personally identifiable info, other people's feedback, admin functions, etc.).

Technical advantages for surgeons are that they save time. They generally cannot watch a 90 minute video of a procedure, especially if they already saw it live. Surgeon students get high quality feedback on their surgeries that are tagged to the moment of action, and they can get a highly qualified surgeon giving feedback. The results are easy to interpret and can help one improve their skills. The system can be cost effective, especially in comparison with other methods that are out there.

In some embodiments, one can embed an iframe of the video player with the sub-section buttons (including the marker graph, the text entry box, the audio and video comment buttons, and the comment graph) into another web site, including social media sites such as Facebook® or Twitter® social media Internet web sites.

A “Set Chapter Start” button may be used in accordance with an embodiment. The “Set Chapter Start” button is presented at the bottom of the screen to set the start time of a sub-section. As a video is playing, it comes upon the start of a sub-section. The user may click the button, which could be titled “Set,” “Set Chapter,” or “Set Chapter,” or otherwise, and this causes the video to pause. A dropdown menu (or “drop up” so that the options are visible without needing to scroll down the screen and away from the video) opens up to show the sub-sections available in the video. The user chooses the appropriate sub-section for that time. The time is recorded as the start of that sub-section.

In alternative embodiments, a “Set Chapter Time” next to the title of each sub-section is clickable to set the current play time of the video as the start time of that subsection.

FIG. 10 illustrates a “Set Current Time” icon in accordance with an embodiment. As the video is playing or paused at any moment, the user can hover over any sub-section link/title and a “Set Current Time” icon appears that, when clicked, sets the sub-section start time at that moment in the video.

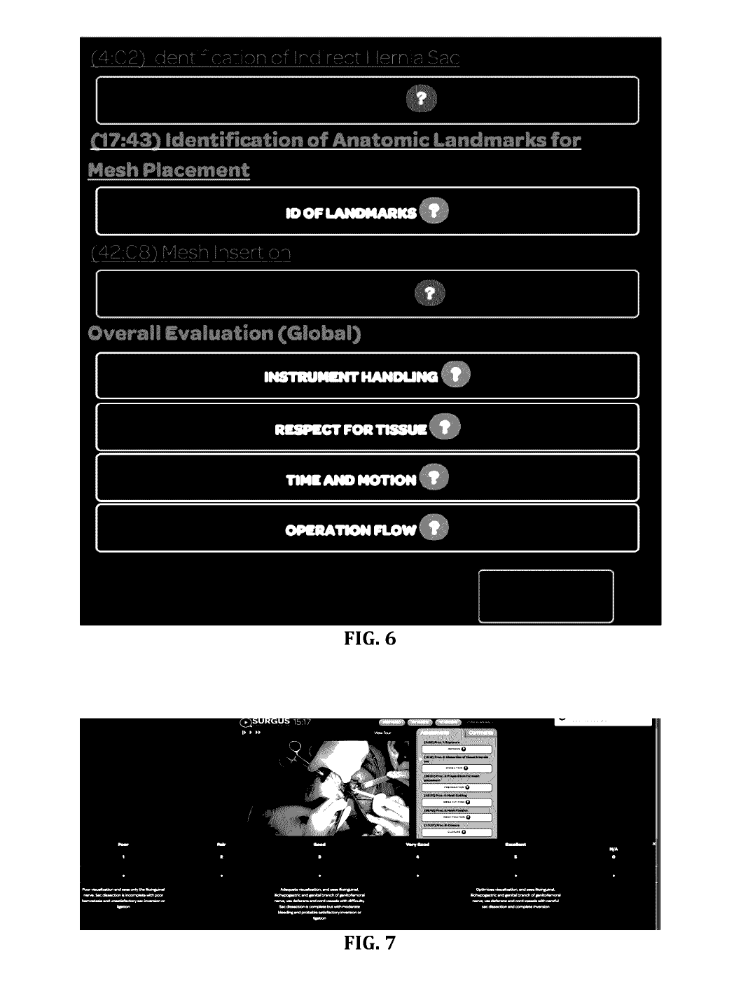

The assessment buttons can be highlighted as solid colors, white outlines, etc. when they are active. They can also flash to call attention to themselves. When they are inactive (i.e. the video is not playing in the corresponding sub-section), then they can be greyed out or changed into a less conspicuous manner than the “active” version. This would include colors that blend more with the background, for example. FIG. 6 illustrates an embodiment where assessment buttons are grayed out when a video is not in the right time period in the video for an assessment. FIG. 7 illustrates an embodiment where when an assessment button is pressed, a pop up window or overlay appears that gives the user scoring options.

Rather than groups, users can be added to default “groups” or lists so that the page delivered on the client-side web has permissions set in advance.

Active chapter titles and links can be shown to be active by larger font size than the inactive ones, brighter text rendering, background of the text getting highlighted, icons such as a check mark, a box around the chapter title. FIG. 9 illustrates an embodiment where the chapter title merely acts as a label. Such chapter titles can also be a link to a particular time point in the video that the user (coach, reviewer, learner) wants to call attention to. As such, it could be used as a “Focus Marker” that would, in the initial state, appear with a label that says, for example, “CREATE FOCUS MOMENT 1,” “CREATE FOCUS MOMENT 2,” or “FOCUS MOMENT 1,” “FOCUS MOMENT 2” or the like, where when a user hovers over it and sets a time as shown in FIG. 10, the label turns into a link a user can click on to play the video at that time. Functionally, this is similar to the markers shown in FIG. 5, but pre-populated, providing for easier use.

When a question metric is waiting for an answer, there can be an icon such as a question mark (“?”) or a star (*) or an emoji such as an unhappy face to on the button to show that it has not been answered. When the metric is answered, then that “unanswered icon” can change to the score provided or to another icon that indicated that it is completed such as a check mark or a happy face emoji.

The metrics to be answered can be as simple as estimating the distance, width, or tightness of features the surgeon performed.

Comparisons of assessments versus a “correct” baseline assessment can be implemented as follows. Since each score and assessment has an associated time-stamp, one could compare the assessment that a reviewer gives the video to a baseline assessment. That comparison can check for how close in time (e.g., 1 ms, 10 ms 100 ms, 1 sec, 2 sec, 3 sec, 5 sec, 8 sec, 10 sec, 12 sec, 15 sec, 20 sec, 30 sec, 60 sec, 90 sec, 120 sec, 240 sec, 360 sec, 600 sec, or otherwise) they identified important moments of assessment to the baseline assessment and the score they gave. The comparison could also include analysis of text, video, or audio that could be compared for key terms. The comparison can score the new assessment quality and accuracy to the baseline and provide a score. For example, if a certain metric were assessed at the same time (within a certain time period) as the baseline, and they gave the same assessment score as the baseline, the new assessment can be judged with a high weight. This comparison of assessments can provide an objective measure of reviewers for qualification to review other videos, or to show their competency. That could be valuable for pre-med students to show that they understand details of surgery, for med students to show their competency in surgery prior to being admitted to residency programs, or residents to show skills competency, or practicing surgeons to show they are conscious of the latest technology and techniques for recertification or comparison of their skills to others in their field.

While an assessment pane is open, which can automatically pause the video, a user can also click on an icon to continue playing the video or scan the video. Or they can click on an answer and the video will resume playing.

The buttons in an inactive subsection can also make the video seek the same way the subsection title links can be clicked to seek the video to that start time to make it active.

FIG. 11 illustrates clickable markers in accordance with an embodiment. Such marker icons can be upward facing triangles (solid or outlines) where the time stamp of the mark is the location of the tip of the triangle such that the user knows that marker will play the video starting at that point.

Drawing on the Video

In order to provide feedback to surgeons, it is often helpful to highlight features on the video, such as certain nerves one may want to avoid severing. Also, it might be helpful to show the direction of a cut or dissection and identify the depth, width, and plane of that dissection.

The user can choose a menu of features to add as an overlay on the video and make multiple clicks on the video rendering such that the program would record the points of the click as a percentage of the player screen (or other vector graphic technique) so that the relative location of the drawings could be rendered on different size screens.

The server side code can collect the user events (clicks) and the associated feature type (circle, plane, pointer) that the user chooses, and the data is saved as a comment tagged to the moment of the video when the user started the process.

The stored data can be rendered as a drawing overlaid on the video whenever the video plays at that point in the timeline by a handler that listens for the comment type and the time.

The drawing can continued to be rendered for a fixed time, and the fade out can be sudden, linear, or exponential.

Highlighted Circle

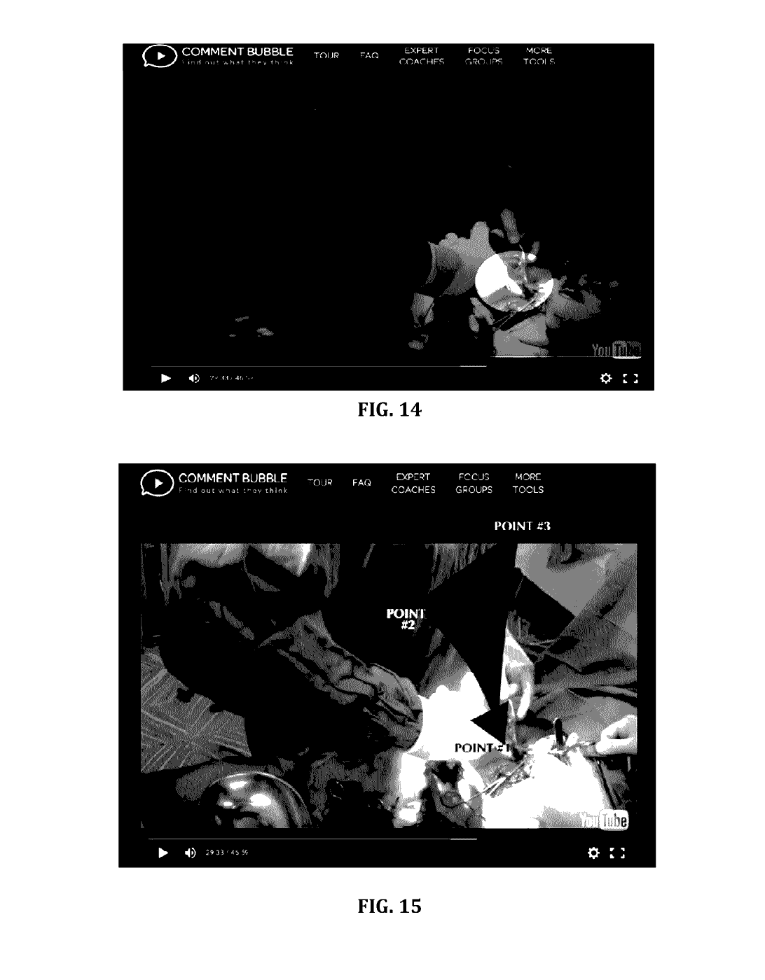

FIG. 14 illustrates marking a video with a highlighted circle in accordance with an embodiment. To draw a circle, a user can first click in the center of the circle. The coordinate can be recorded as a percentage of the x and y width of the screen so that the relative location is the same regardless of the device screen size. Then, the user moves the cursor to a second point on the video, the distance from the first click to the second is the radius of the circle. The area around the circle is automatically darkened with an opacity between 20% to 100% (50% shown in the figure).

Other clicks can define other coordinates and/or change the shape of the highlighted region. For example, a third click perpendicular from a line between the first and second clicks can define a major or minor axis of an ellipse, and the circle can turn into an ellipse.

Triangles and arrowheads can quickly be drawn to show a 3-D aspect to the markups in accordance with an embodiment. There could be a gradient of color and/or intensity from side between the different points on the triangle to help a user visualize the 3-D effect.

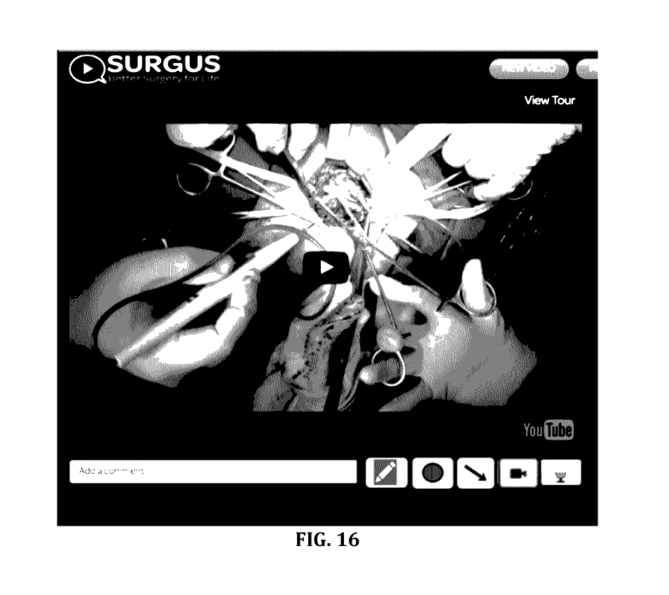

3-D markups for particular surgical techniques may be identified in a number of ways in accordance with an embodiment. A wide and shallow dissection (for example, a 10 blade or a saw) may be indicated by using an arrowhead with a gradient, scalloped edges, and an arrow tip. FIG. 15 illustrates use of an arrow by a user as feedback by clicking 3 points, the apex (point #1) and the two rear ends of the arrow, such that the head of the arrow will indicate a percentage of the distance between Point #2 and Point #3, such that if the distance between points 2 and 3 is narrow, that will signify a puncture whereas if the distance is large relative to the video window, that will represent a slice or cutting motion. The length of the arrow head is typically 10%-25% of the distance between Point #1 and either of Point #2 or Point #3. As shown in FIG. 16, various tools can be used to provide directly feedback at specific time points in a video including audio feedback, text feedback, drawings, circle highlights, arrows and video feedback.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope.

What is claimed is:

1. A computer-implemented method for annotating a video presentation, the method comprising:
presenting a graphical interface that includes a motion video presentation, a timeline graph indicating time points within the video presentation, a current playback moment of the video presentation, and a plurality of user-selectable interface elements;
playing the video presentation for a user;
receiving a user selection of at least a first time point in the video presentation;
selecting user input for at least a first time point in the video presentation; and
providing input in the video presentation in the form of one or more of textual descriptions, audio input, video input, drawings, uploaded links, uploaded pictures, uploaded videos or a rating score.

2. The method of claim 1, further comprising annotating said video presentation at one or more of a second, third, fourth, fifth and a sixth time point in the video presentation, wherein each time point corresponds to an assessment point for a particular stage of a surgical procedure.

3. A computer-implemented method for scoring a subsection of a video presentation, the method comprising:
presenting a graphical interface that includes a motion video presentation, a timeline graph indicating subsections within the video presentation, a current playback moment of the video presentation including a fast forward option, and a plurality of disabled user-selectable interface elements,
playing the video presentation for a user;
enabling a first user-selectable interface element upon the current playback moment entering a subsection within the video presentation;
receiving, through the graphical interface, a selection of the first user-selectable interface element;
overlaying a scorecard interface over a portion of the graphical interface in response to receiving the selection, the scorecard including user-selectable values and text describing each value;
storing a score chosen from the scorecard interface.

4. The method of claim 3, further comprising:
pausing the motion video presentation based on the receiving selection of the first user-selectable interface element.

5. The method of claim 3, further comprising:
enabling the second user-selectable interface element based on the current playback moment entering a second subsection within the video presentation.

6. The method of claim 5, further comprising:
pausing the motion video presentation based on the receiving selection of the second user-selectable interface element.

7. The method of claim 3, wherein the portion of the graphical interface overlaid with the scorecard interface includes all or a portion of the timeline graph, wherein said timeline graph includes tools for entry of feedback.

8. The method of claim 3, wherein a portion of the graphical interface includes a bar graph where input from one or more reviewers for each subsection of a video presentation is presented and accessible to users.

9. The method of claim 3, wherein the portion of the graphical interface overlaid with the scorecard interface includes all or a portion of the video presentation.

10. The method of claim 3, wherein the graphical interface is on a web page.

11. The method of claim 3, wherein the method for scoring the video presentation is automated.

12. A computer-implemented method for annotating subsections of a video presentation, comprising:
a video presentation comprising a graphical interface having no permissions or metrics assigned;
assigning one or more permissions or metrics selected from the group consisting of a timeline graph, assessment sections, a bar graph, and user-selectable interface elements to the graphical interface;
customizing the graphical interface to create assessment sections, each assessment section indicating a range of values for scores, and
further customizing the graphical interface to provide user input by way of user-selectable interface elements during video playback; and
storing the assessment and user input for later playback.
